(19) United States
(12) Patent Application Publication
(10) Pub. No.: US 2004/0177744 A1
(43) Pub. Date: Sep. 16, 2004

(54) Device and method for evaluating vocal performance

(75) Inventors: Thomas Strasser, Manaus (BR); Nivaldo Antonio Portela de Vasconcelos, Manaus (BR); Hallyson Luiz de Morais Melo, Manaus (BR); Andre Jardim da Trindade, Manaus (BR)

Correspondence Address: STEINBERG & RASKIN, P.C., 1140 AVENUE OF THE AMERICAS, 15th FLOOR, NEW YORK, NY, 10036-5803, US

(73) Assignee: Genius - Instituto De Tecnologia

(21) Appl. No.: 10/608,450

(22) Filed: Jun. 27, 2003

(30) Foreign Application Priority Data
Jul. 4, 2002 (BR) PI0202561-2

(51) Int. Cl. G09B 15/00

(52) U.S. Cl. 84/470 R; 434/307 A

(57) ABSTRACT

A system for evaluating vocal performance based on an entry device that provides a sequence of blocks of samples from the singer's voice signal to be evaluated, and a sequence of blocks of samples from a reference voice signal, and on the measurement of the similarity between the signals supplied by the entry device, through the processing of multiple aspects, and which foresees a device for the delivery of information to be used for the generation of visual and auditory feedback for didactic purposes in relation to the partial results of said comparisons, and visual and auditory feedback for didactic purposes in relation to the final result of said evaluation of similarity, as well as a summary of the evaluation of similarity of each one of said aspects; and a method of adaptation that allows the addition, removal, or modification of the aspects of said set of aspects, which therefore makes the device modular, allowing the adjustment of the level of quality of said evaluations of similarity carried out based on the processing of the singer's voice and the reference voice, so as to adequate said evaluations of similarity to the computational resources available, therefore providing the device with scalar characteristics.

### FIELD OF THE INVENTION

The present relation relates to a device and a method for evaluating vocal performance, destined to evaluate various aspects of a singer's performance in comparison to a reference voice; to provide the singer, during the evaluation, with visual indication of how to improve his/her performance; and to present, at the end of the evaluation, a general report on the singer's performance, which shall include a summary of his/her performance to each aspect and a final general result.

### BACKGROUND OF THE INVENTION

The device in question was developed modularly, in order that it allows the insertion or removal of aspects to be evaluated, and in a scaleable way, so as it may be used in systems with different computational resources available for the execution of the evaluation.

The device object hereof was developed to be used specifically, but not exclusively, in electronic systems equipped with the function of vocal substitution in songs, widely known as karaoke.

As known, the system of vocal substitution in songs (karaoke) basically operates by removing from the song the audio signal correspondent to the reference voice, which will be substituted by inserting the audio signal correspondent to the singer's voice.

FIG. 1 attached hereto demonstrates a block diagram of an equipment incorporating an usual system of voice substitution (or karaoke) (I). As illustrated in said block diagram, a original song is an audio signal originated from an audio source (1), which may be a DVD, CD, a memory, or any other source. The system (I) foresees the removal (2) of the voice signal from the original song, which is made through algorithms or adequate filters, depending on the type (analogical or digital) and on the codification of the audio signal. Said system (I) also foresees the inclusion (3) of the singer's voice signal [originated from a microphone (4), for instance], which is made through a mixing procedure (or mixture), or through simultaneous and synchronized reproduction of the accompaniment and voice of the singer.

In order to improve the capacity of entertainment of these usual systems for vocal substitution (or karaoke), the singer generally receives a score for his/her performance at the end of the song.

Various examples of karaoke apparatus with function of calculation of score are broadly known. One of them consists in the object of U.S. Pat. No. 5,557,056, wherein the score is calculated by comparing the volume of the song's accompaniment signal and the volume of the singer's voice signal. U.S. Pat. No. 5,719,344 also foresees a method to provide a score based on the measurement of the reference voice signal and the singer's voice signal.

U.S. Pat. No. 6,326,536 foresees a method for the calculation of score based on the volume measured of the reference voice and the singer's voice, proposed to computational systems with low processing capacity.

More recently, improvements have been proposed in order to increase the entertainment of users, such as the competition system included in U.S. Pat. No. 6,352,432. In this patent, various singers may sing simultaneously the same song, obtaining information of superiority/inferiority of a singer in relation to the others while singing. This same information is submitted in the form of images that represent a contest between animated characters. This equipment uses information of tone, rhythm, and volume.

U.S. Pat. No. 5,750,912 proposes the alteration of the singer's voice according to the original song by using information of tone, so as it reproduces a performance better than the original. U.S. Pat. No. 5,804,752, on its turn, proposes a method for attributing individual scores to two singers singing in duet.

Various deficiencies have been observed in the solutions proposed. First of all, the devices proposing the evaluation of determined aspects of the singer's performance require high amount of computational resources, which makes the product expensive. On the other hand, the devices that may be used under limited computational resources fail due to the evaluation of the volume only, which is extremely dependent on the equipment and respective accessories, especially the microphone, and not intrinsically related to the singer's performance.

The devices of evaluation proposed also fail when providing the result only at the end of the song. And when these devices evaluate the singer's performance in more than one aspect, they do not present the results individually, which impedes the singer from having tips of how to improve his/her performance in each individual aspect.

Thus, none of the solutions proposed provides the singer with detailed information on his/her performance while singing, which would allow him/her to improve the performance during the song, nor information at the end of the song of how the singer could improve his/her performance for next time.

The sole apparent exception is the system proposed in U.S. Pat. No. 6,352,432 mentioned above. However, this system indicates only if the singer's performance is better or worse than another singer competing with him/her, not indicating how the singer could improve his/her performance.

In summary, there is not an evaluating device that may be used both in equipment with low level of computational resources available and in equipment with high level of computational resources and, therefore, more expensive, that provides the evaluation of each aspect of the singer independently, during and at the end of the song, in order to guide the singer concerning his/her performance and allowing the easy inclusion and removal of the aspects evaluated.

### SUMMARY AND OBJECTS OF THE INVENTION

Aiming to provide an evaluating device that integrates all these characteristics and that would consequently eliminate the deficiencies in the evaluating devices known, this device and method for evaluating vocal performance is created to be used in various types of systems and environments, not limited to specific sections of the karaoke market, nor to this market only, but also to other equipment, including the use by professional singers. The device invented herein further provides an evaluation with quality superior to the best evaluating devices currently available on the market, due to the utilization of a adequateness and calibration method of said evaluation.

The main aspects in which the sound description is based generally are:

Melody (or tone): sequence of the fundamental frequencies of each note;

Rhythm: sequence of duration of each note;

Timbre: spectral compound of each note;

Harmony: combination of two or more notes played simultaneously.

Satisfactory results of evaluation may be obtained by using melody, rhythm, and volume of voice signals, considering that the device object hereof allow the use of any sets of aspects.

The device object hereof foresees the characteristics of modularity, which allows the addition, removal, or modification of the aspects (modules) of evaluation, and of scale, which allow the redefinition of the aspects to be evaluated and the re-dimensioning of the resources necessary for processing the singer's voice and the reference voice. Then, the incorporation of the evaluating device proposed herein to various systems is possible, such as processor attached to DVD equipment (regardless of the platform used), in digital signal processors (DSP), or in other platforms, whether as software or hardware. Thus, the device in question allows an adequateness of the quality of evaluation to the computational resources available.

### BRIEF DESCRIPTION OF THE DRAWINGS

A more complete appreciation of the present invention and many of the attendant advantages thereof will be readily understood by reference to the following detailed description when taken in conjunction with the accompanying drawings, in which:

FIG. 1 is a block diagram of equipment incorporating an usual system of voice substitution according to the state of the art;

FIG. 2 is a block diagram of equipment that incorporates a system of vocal substitution and an evaluating device according to the invention.

### DETAILED DESCRIPTION OF THE INVENTION

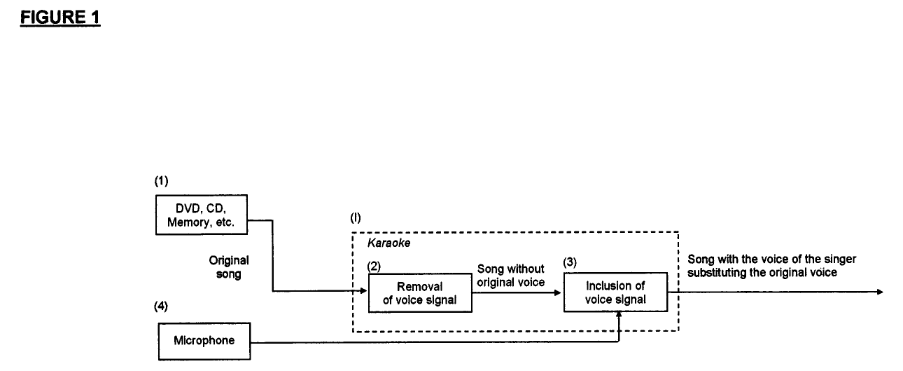

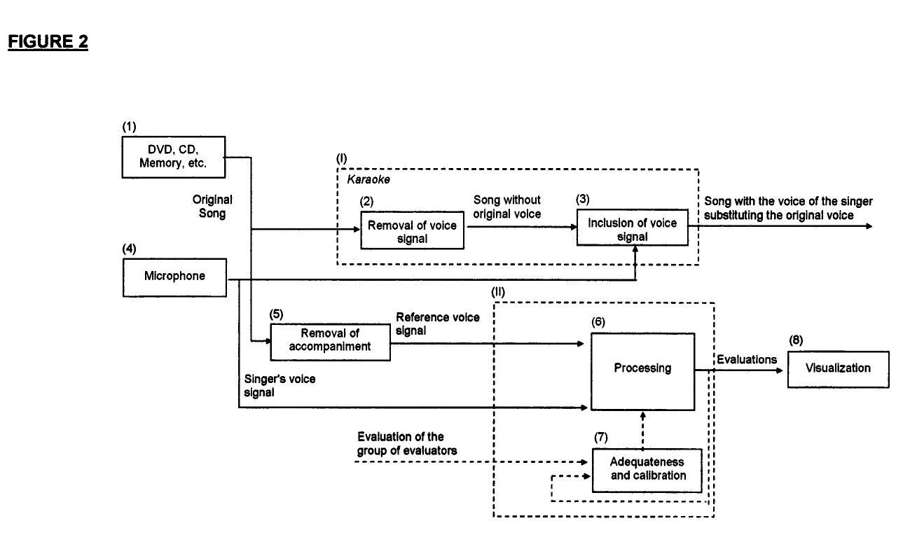

FIG. 2 attached hereto demonstrates a block diagram of an equipment that incorporates an usual system of vocal substitution (which may be a karaoke), such as the one illustrated in FIG. 1, however incorporating the evaluating device object of this invention (II).

As illustrated in said block diagram, the original song is an audio signal originated from an audio source (1), which may be a DVD, CD, a memory, or any other source. The system (I) foresees the removal (2) of the reference signal, and the inclusion (3) of the singer's voice signal [from a microphone, for instance (4)].

As illustrated in the same block diagram, the evaluating device invented herein (II) receives, as input, the signal of the reference voice removed from the original song originated in the source (1), from which the accompaniment (5) is removed, as well as the singer's voice signal obtained, for instance, from the audio signal generated by the microphone (4). The evaluation is carried out by processing (6) the signals received as entry. The adequateness of said processing to the computational resources available and the calibration of the results of the evaluation are carried out whenever the device is modified or transported to new platforms by an adequateness and calibration method (7), which uses information of calibration originated from the results of the evaluation of a heterogeneous group of human evaluators, and from the results of the evaluation of the device for the same set of singing executions. The result of the evaluation is submitted to the user interface device (8), which generates visual and auditory feedback during the execution of the song, providing information on the various evaluated aspects, and, at the end of the song, a visual and auditory evaluation representing the general performance of the singer evaluated and the performance in relation to each one of the aspects evaluated.

The device of visual feedback uses icons, sentences, and sounds to provide the singer with instantaneous and individual evaluation of each aspect during the song, in order to indicate the singer how he/she may improve the performance.

In order to guarantee the quality of the result of the evaluation, a data base of evaluation was prepared through the realization of field tests with a significant number of volunteer evaluators. The tests consisted in recording the singer performance of a heterogeneous group of singers and in registering, by each volunteer evaluator, the evaluation of performance of the respective singer. After all evaluations are complete, they were tabulated and used as a calibration standards of the global evaluation of the singer supplied by the device.

Concerning the modular and scalar characteristic of the device invented herein, and in order to allow its easy adaptation and portability, the evaluating device in question presents the following characteristics:

The device foresees the standardization of the interface in the implementation of the evaluation of each aspect, allowing the addition, removal, and/or modification of a determined aspect. Additionally, the processing of inputs may be defined based on the relation between the quality of its results and the quantity of computational resources consumed thereby.

The device further foresees the standardization of the interface in the implementation of the acquisition of samples. This allows any combination of reference channels and evaluated channels to be implemented with minimum effort.

The device foresees the parameterization of the acquisition of samples. Thus, to each reference channel or to each evaluated channel, the alteration in the sampling rate and other parameters related to the acquisition may be carried out with minimum effort. This is important to the portability, since the parameters of acquisition depend on the apparatus wherein the device is built in.

Finally, the device foresees the simplification of its interface as a whole, through the standardization of the entry and exit devices. Thus, the task of building the device in a determined apparatus involves few alterations in the original system.

Once the processing is defined in order to adequate the device to the quantity of computational resources available, the calibration of the device for the maximization of the evaluating quality is made through the optimization of the similarity of the results collected from the evaluation of performance of an heterogeneous group of singers by an heterogeneous group of human evaluators, and from the results collected from the evaluation of the same executions in the same group of singers by the evaluating device invented herein (with the limitations of resources applicable). The more computational resources are available, the better will be the evaluations. The scalar characteristic allows that these resources may be used on an improved manner, supplying an evaluation of quality superior to those known, due to the set of resources available.

The advantages of the implementation of the device invented herein are: possibility of solution of additional hardware components with zero cost, in case of implementation of the device in software; large flexibility, allowing the development of an evaluating device with more quality than those currently existent in commercial apparatuses, even with limited computational resources; and the possibility of implementation in different platforms.

1. A system for evaluating vocal performance, comprising:
an entry device that provides a sequence of blocks of samples from the singer's voice signal to be evaluated, and a sequence of blocks of samples from a reference voice signal, and on the measurement of the similarity between the signals supplied by the entry device, through the processing of multiple aspects, and
a device for the delivery of information to be used for the generation of visual and auditory feedback for didactic purposes in relation to the partial results of said comparisons, and visual and auditory feedback for didactic purposes in relation to the final result of said evaluation of similarity, as well as a summary of the evaluation of similarity of each one of said aspects; method of adaptation that allows the addition, removal, or modification of the aspects of said set of aspects, which therefore makes the device modular, allowing the adjustment of the level of quality of said evaluations of similarity carried out based on the processing of the singer's voice and the reference voice, so as to adequate said evaluations of similarity to the computational resources available, therefore providing the device with scalar characteristics.

2. The evaluating system according to claim 1, wherein the evaluating system is likely to be embedded into various systems, such as systems of vocal substitution in songs (karaoke), processors of DVD, CD apparatus, etc., digital signal processors (DSP), or any other platforms, whether as software or hardware.

3. The evaluating system according to claim 1, further comprising a feedback device that uses icons, phrases and sounds to provide the singer evaluated during the execution of the song, visually and acoustically, with instantaneous and individual evaluations of each aspect evaluated based on the results of the processing of the voice of the singer evaluated and the reference voice, in periods determined experimentally, and, at the end, a summary reporting the performance of the singer evaluated in each aspect, so as it may indicate how the singer evaluated may improve his/her performance during the execution of the song and on the next time.

4. The evaluating system according to claim 1, wherein the system allows the alteration, by adding, removing or modifying aspects to be used in the evaluation, and modification of the processing of the voice of the evaluated singer and the reference voice, making the system modular and scalar.

5. The evaluating system according to claim 1, wherein the system includes a method of adequateness and calibration of the device for evaluating vocal performance to the set of computational resources available, aiming to maximize the quality of the evaluation, by optimizing the similarity between the results collected from the evaluation of performance of a heterogeneous group of singers by a heterogeneous group of human evaluators, and the results collected from the evaluation of the same executions of the same group of singers by said evaluating device submitted to the limitations of computational resources applicable and to said pertinent alterations.

6. The evaluating system according to claim 5, further comprising a feedback device that uses icons, phrases, and sounds to provide the singer visually and auditorily with a global evaluation of his/her performance at the end of the song, based on the results of the processing of the voice of the singer evaluated and the reference voice, and calibrated by said method of adequateness and calibration, in order to simulate the evaluation of a heterogeneous group of human evaluators.
